(19) United States
(12) Patent Application Publication
(10) Pub. No.: US 2024/0317371 A1
(43) Pub. Date: Sep. 26, 2024

(54) SUBMERSIBLE THRUSTER

(71) Applicant: SHENZHEN WAYDOO INTELLIGENCE TECHNOLOGY CO., LTD., Shenzhen (CN)

(72) Inventors: Qiuyang ZHU, Shenzhen (CN); Ping TIAN, Shenzhen (CN); Tao ZHAO, Shenzhen (CN); Zhi HUANG, Shenzhen (CN)

(73) Assignee: SHENZHEN WAYDOO INTELLIGENCE TECHNOLOGY CO., LTD., Shenzhen (CN)

(21) Appl. No.: 18/735,779

(22) Filed: Jun. 6, 2024

Related U.S. Application Data
(63) Continuation-in-part of application No. PCT/CN2022/136480, filed on Dec. 5, 2022.

(30) Foreign Application Priority Data
Dec. 10, 2021 (CN) 202123109598.2

(51) Int. Cl. B63C 11/46

(52) U.S. Cl. CPC B63C 11/46

(57) ABSTRACT

A submersible thruster includes a housing, a fixing component and a battery member. A containment cavity is formed inside the housing, the fixing component is positioned in the containment cavity; the battery member is fixedly and arranged in the containment cavity through the fixing component, the battery member is connected to the fixing component to form an integrated structure, and the fixing component is fixedly and arranged in the containment cavity and connected to the housing to form an integrated structure; in this way, the battery member can be fixedly installed in the housing, making the battery member and the housing an integrated structure, and the fixing component and the housing an integrated structure, the integrated setup makes the submersible thruster achieve the technical effect of simple internal structure thereof.

### CROSS-REFERENCE TO RELATED APPLICATIONS

This application is a continuation-in-part application of International Application No. PCT/CN2022/136480, filed on Dec. 5, 2022, which claims priority to Chinese Patent Application No. 202123109598.2, filed on Dec. 10, 2021. All of the aforementioned applications are incorporated herein by reference in their entireties.

### TECHNICAL FIELD

The present disclosure herein relates to the technical field of diving equipment, in particular to a submersible thruster.

### BACKGROUND

Most of the submersible thrusters are driven by electric propulsion, and since they need to operate underwater for a long time at a certain depth, they need to be equipped with battery member to supply power to the submersible thruster when they go underwater.

Currently, the existing battery member is connected to the submersible thruster in a detachable way, which requires the submersible thruster to be equipped with a matching detachable structure and reserved operating space inside, resulting in the structure of the submersible thruster being too complicated.

### SUMMARY

The main purpose of the present disclosure is to provide a submersible thruster, which aims to solve the technical problem of complex structure of the submersible thruster by fixing a battery member inside the submersible thruster.

In order to achieve the above purpose, the present disclosure proposes a submersible thruster, the submersible thruster comprises a housing, a fixing component and a battery member, a containment cavity is formed inside the housing, the fixing component is positioned in the containment cavity, and the battery member is connected to the fixing component to form an integrated structure, and the fixing component is fixedly and arranged in the containment cavity and connected to the housing to form an integrated structure.

Optionally, the fixing component includes a fixing housing and a fixing rod, a fixing cavity formed inside the fixing housing, and the battery member is fixedly and installed in the fixing cavity, and an avoidance groove is formed on an outer side wall of the fixing housing, the fixing rod penetrates the fixing housing through the avoidance groove, and an opposite ends of the fixing rod are connected to the housing respectively.

Optionally, the fixing component further includes two fixing seats, the two fixing seats are arranged on an opposite sides of the housing respectively, and the opposite ends of the fixing rod are connected to the two fixing seats respectively.

Optionally, the outer side wall of the fixing housing is provided with a pick-up port connected to the fixing cavity.

Optionally, a drive mounting position is arranged on the fixing housing.

Optionally, the submersible thruster further includes a charging component, the charging component is arranged on one side of the housing and is connected to one end of the fixing component, the housing and the charging component are enclosed to form the containment cavity therebetween, and the charging component is electrically connected to the battery member.

Optionally, the charging component includes a charging connector and a power circuit board, the power circuit board is connected to one end of the fixing component and electrically connected to the battery member, and the charging connector is electrically connected to the power circuit board and is partially exposed outside the housing.

Optionally, the submersible thruster further includes a driving component, the driving component is arranged on an other side of the housing and is connected to an other end of the fixing component, the housing, the charging component, and the driving component are enclosed to form the containment cavity therebetween, and the driving component is electrically connected to the battery member.

Optionally, the driving component includes a driving member and a driving circuit board, the driving member is connected to the other end of the fixing component, the driving circuit board is arranged on the fixing component, and the driving circuit board is electrically connected to the battery member and the driving member respectively.

Optionally, the housing is provided with a connecting through hole outside.

The technical solution of the present disclosure consists of a housing, a fixing component and a battery member, wherein a containment cavity is formed inside the housing, the fixing component is positioned in the containment cavity, and the battery member is fixedly and arranged in the containment cavity through the fixing component, the battery member is connected to the fixing component to form an integrated structure, and the fixing component is fixedly and arranged in the containment cavity and connected to the housing to form an integrated structure; in this way, the battery member can be fixedly installed in the housing, making the battery member and the housing an integrated structure, and the fixing component and the housing an integrated structure, so as to solve the technical problems in the prior art of the battery member and the submersible thruster as a detachable structure resulting in a very complex internal structure of the submersible thruster, and the integrated setup makes the submersible thruster achieve the technical effect of simple internal structure thereof.

### BRIEF DESCRIPTION OF THE DRAWINGS

In order to more clearly illustrate the technical solutions in the embodiments of the present disclosure or the prior art, the following will briefly introduce the accompanying drawings that need to be used in the description of the embodiments or the prior art, and it is obvious that the accompanying drawings in the following description are only some of the embodiments of the present disclosure, and for those ordinary skilled in the art, other accompanying drawings can be obtained based on the structures illustrated in the accompanying drawings without creative labor.

FIG. 1 shows a structure schematic diagram of a submersible thruster of the present disclosure.

FIG. 2 shows a vertical sectional view of a submersible thruster in FIG. 1.

FIG. 3 shows a structure schematic diagram of a fixing component in FIG. 2.

FIG. 4 shows a partially enlarged view at position A in FIG. 3.

FIG. 5 shows a structure schematic diagram of an omitted housing of a submersible thruster of the present disclosure.

FIG. 6 shows a partial decomposition diagram of a submersible thruster of the present disclosure.

### DETAILED DESCRIPTION OF THE EMBODIMENTS

The technical solutions in the embodiments of the present disclosure will be clearly and completely described below in conjunction with the accompanying drawings in the embodiments of the present disclosure, and it is clear that the described embodiments are only a part of the embodiments of the present disclosure and not all of the embodiments. Based on the embodiments in the present disclosure, all other embodiments obtained by those ordinary skilled in the art without making creative labor fall within the scope of protection of the present disclosure.

It should be noted that all directional indications (such as up, down, left, right, forward, backward.) in the embodiments of the present disclosure are only used to explain the relative positional relationship, movement, and the like among the various components in a particular posture (as shown in the accompanying drawings), and that the directional indications are changed accordingly if the particular posture is changed.

Furthermore, the descriptions involving “first”, “second”, and the like in the present disclosure are used for descriptive purposes only, and are not to be construed as indicating or implying its relative importance or implicitly specifying the number of technical features indicated. As a result, a feature defined as “first” or “second” may include at least one such feature, either explicitly or implicitly. In addition, the technical solutions between the various embodiments may be combined with each other, but it must be based on the fact that those ordinary skilled in the art can realize it, and when the combination of the technical solutions is contradictory or unattainable, it should be considered that the combination of such technical solutions does not exist, and is not within the scope of protection of the present disclosure.

The battery member 50 of the submersible thruster 100 currently on the market is installed into the submersible thruster in a detachable way, and this installation method will make the internal structure of the submersible thruster 100 too complicated, requiring a corresponding disassembly structure to be matched with the battery member 50 for detachable installation and a certain space needs to be reserved to facilitate operation during assembly; secondly, the detachable method will also leads to the risk of water intrusion at the connection between the battery member 50 and the components of the submersible thruster 100, which requires additional sealing members to be provided to seal the connection.

The present disclosure proposes a submersible thruster 100.

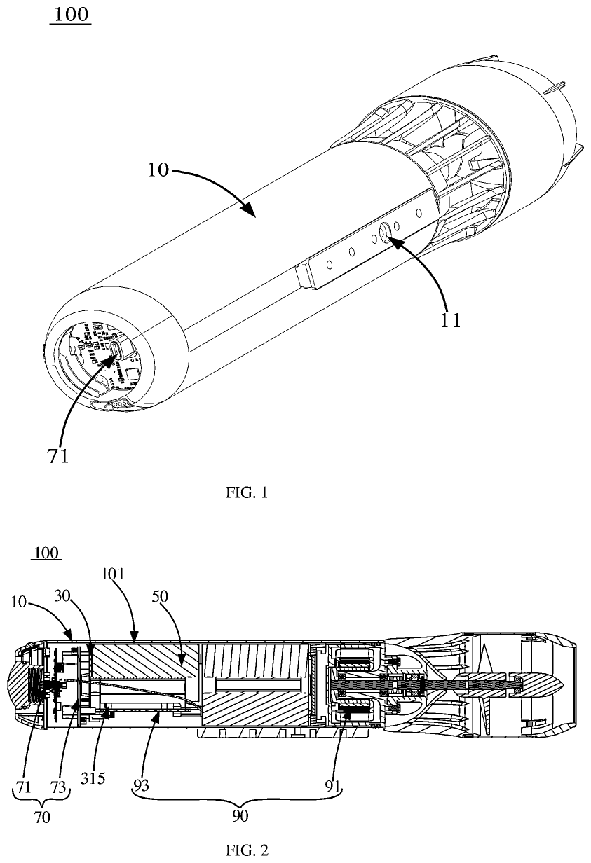

In this embodiment of the present disclosure, as shown in FIG. 1 and FIG. 2, the submersible thruster 100 comprises a housing 10, a fixing component 30, and a battery member 50, wherein a containment cavity 101 is formed inside the housing 10, the fixing component 30 is positioned in the containment cavity 101, the battery member 50 is connected to the fixing component 30 to form an integrated structure, and the fixing component 30 is fixedly and arranged in the containment cavity 101 and connected to the housing 10 to form an integrated structure.

In an embodiment, the battery member 50 is provided so that the components of the submersible thruster 100 can be powered, and the fixing component 30 is provided so that the battery member 50 can be fixedly installed in the containment cavity 101 inside the housing 10, and will not be affected by the impact of the water pressure or other factors during the underwater operation, so that the battery member 50 can always be well fixed inside the containment cavity 101, and the wires connected to the battery member 50 can also maintain stability. Here, the battery member 50 is preferably a rechargeable battery to ensure long-term and multiple use, but of course, a disposable battery can also be selected, and is not specifically limited herein.

The fixing component 30 fixes the battery member 50 inside the housing 10, so that the battery member 50 and the housing 10 are an integral structure within the submersible thruster 100, and the housing 10 and the fixing component 30 are also an integral structure; compared to the battery member 50 and the submersible thruster 100 being a detachable structure, in the integrated structure of the battery member 50 and the submersible thruster 100, the submersible thruster 100 does not need to provide an additional detachable structure, and there is no need for an operating space during internal detachable assembly, thereby making the structure of the submersible thruster 100 simpler, and the size can be reduced, wherein the sealing of the submersible thruster 100 can also be maintained, and the integrated structure reduces the risk of water intrusion in the connection compared to the detachable structure, thereby improving the sealing and waterproofing performance of the submersible thruster 100.

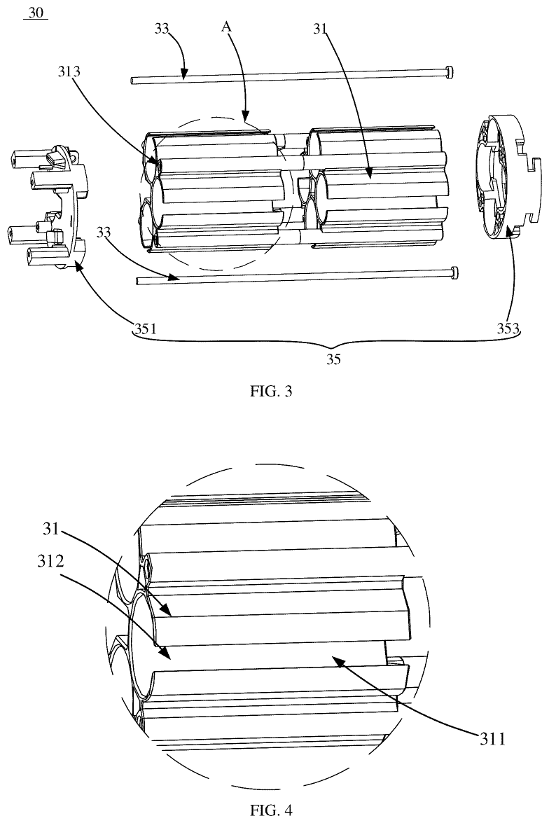

In an embodiment of the present disclosure, as shown in FIG. 3, the fixing component 30 includes a fixing housing 31 and a fixing rod 33, wherein a fixing cavity 312 formed inside the fixing housing 31, and the battery member 50 is fixedly and installed in the fixing cavity 312, and an avoidance groove 313 is formed on an outer side wall of the fixing housing 31, the fixing rod 33 penetrates the fixing housing 31 through the avoidance groove 313, and an opposite ends of the fixing rod 33 are connected to the housing 10 respectively.

In an embodiment, the fixing rod 33 is provided so that the fixing housing 31 can be installed in the containment cavity 101 inside the housing 10, and at the same time the fixing housing 31 is provided with the fixing cavity 312 inside, and the battery member 50 is installed in the fixing cavity 312, so that the fixing rod 33 can be installed in the containment cavity 101 inside the housing 10; the material of the fixing housing 31 may be selected from plastic and metal and so on, and the material of the fixing housing 31 is specifically limited herein to ensure that the battery member 50 in the fixing housing 31 can maintain stability, as long as the material itself has a certain degree of hardness, it can be chosen.

The fixing housing 31 and the fixing rod 33 are provided so that the battery member 50 can be fixedly installed in the fixing cavity 312 inside the housing 10, thereby making the battery member 50 and the submersible thruster 100 an integrated arrangement, and the fixation is high, enabling the battery member 50 to remain fixed inside the housing 10, with a simple structure, low production cost, and good fixation effect.

In an embodiment of the present disclosure, as shown in FIG. 3, the fixing component 30 further includes two fixing seats 35, the two fixing seats 35 are arranged on an opposite sides of the housing 10 respectively, and the opposite ends of the fixing rod 33 are connected to the two fixing seats 35 respectively.

In an embodiment, the two fixing seats 35 are a first fixing seat 351 and a second fixing seat 353, respectively, a charging component 70 is installed on the first fixing seat 351, a driving component 90 is installed on the second fixing seat 353, and the opposite ends of the fixing rod 33 are connected to the first fixing seat 351 and the second fixing seat 353, respectively, so as to enable the fixing rod 33 to be erected in the space inside the fixing cavity 312.

The two fixing seats 35 are provided so that the fixing component 30 has better fixing for the battery member 50, and the fixing seats 35 can be separately installed with other components, making the integration and accommodation within the submersible thruster 100 higher, so as to make the structure of the submersible thruster 100 simpler, and the size can be further reduced.

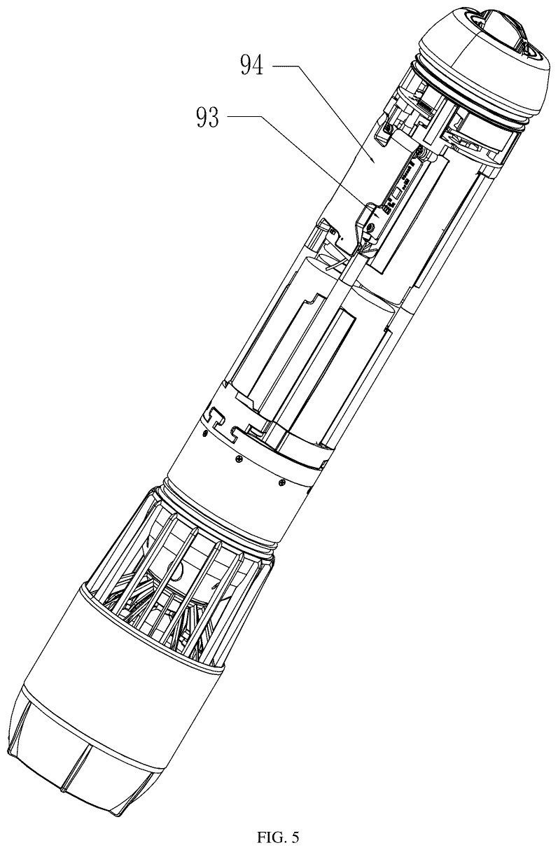

In an embodiment of the present disclosure, as shown in FIG. 4, the outer side wall of the fixing housing 31 is provided with a pick-up port 311.

In an embodiment, the space inside the pick-up port 311 is made larger by deforming the pick-up port 311 to a certain extent, so that when the battery member 50 is installed or removed from the fixed housing 31, the operation convenience is greatly improved; it is explained herein that the pick-up port 311 is provided to ensure that the battery member 50 can be fixed in the fixing cavity 312 inside the fixing housing 31 without being deformed, and that, in the case of deformation, the space inside the pick-up port 311 can ensure that the battery member 50 can be removed from the fixing housing 31, and the size and shape of the pick-up port 311 can be selected according to the size of the battery member 50, and will not be specifically limited herein.

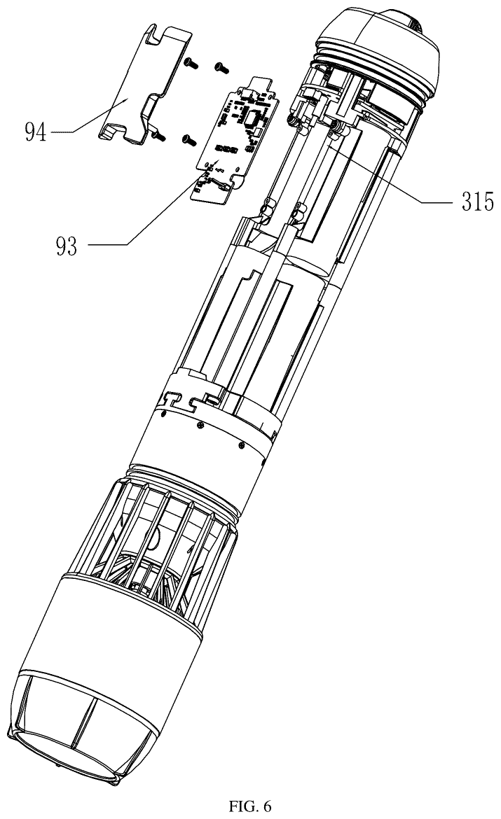

In an embodiment of the present disclosure, as shown in FIG. 2, FIG. 5 and FIG. 6, a drive mounting position 315 is arranged on the fixing housing 31.

In an embodiment, the drive mounting position 315 includes a plurality of screw holes, a space is reserved on the fixing housing 31 for installing the driving circuit board 93, a plurality of through holes are arranged on the driving circuit board 93 to cooperate with the screw holes, and the driving circuit board 93 is fixed to the drive mounting position 315 by means of screws; the installation method is simple in structure, and the drive mounting position 315 is arranged on the fixing housing 31; the advantage of installing the driving circuit board 93 is that the space inside the fixing housing 31 can be effectively utilized, and the overall size of the submersible thruster 100 can be reduced; in this embodiment, the outer side of the driving circuit board 93 is covered with a protective plate 94, a plurality of insertion posts are arranged on the protective plate 94, a plurality of sockets are arranged on the fixing housing 31, and the protective plate 94 is installed on the fixing housing 31 through the cooperation of the insertion posts and the sockets.

In an embodiment of the present disclosure, as shown in FIG. 2, the submersible thruster 100 further includes a charging component 70, the charging component 70 is arranged on one side of the housing 10 and is connected to one end of the fixing component 30, the housing 10 and the charging component 70 are enclosed to form the containment cavity 101 therebetween, and the charging component 70 is electrically connected to the battery member 50.

In an embodiment, the charging component 70 is provided so that the charging component 70 can be electrically connected to the battery member 50, and the charging component 70 can charge the battery member 50, thereby enabling the battery member 50 to maintain a power level through the charging component 70 when the battery member 50 is integrally fixed inside the housing 10, which in turn ensures that the submersible thruster 100 can carry out underwater operation for a long period of time under the condition that the battery is sufficiently charged.

In an embodiment of the present disclosure, as shown in FIG. 1 to FIG. 2, the charging component 70 includes a charging connector 71 and a power circuit board 73, the power circuit board 73 is connected to one end of the fixing component 30 and electrically connected to the battery member 50, and the charging connector 71 is electrically connected to the power circuit board 73 and is partially exposed outside the housing 10.

In an embodiment, the charging connector 71 is provided so that an external power source can charge the battery member 50 through the charging connector 71, and the power circuit board 73 can manage the functions of the battery member 50, so that when the battery member 50 is integrally fixed inside the housing 10, its power can be replenished and controlled; the type of the interface of the charging connector 71 can be selected from a Micro Universal Serial Bus (USB) interface, a USB Type C interface, a Lightning interface, and so on, and the USB Type C interface is selected herein, as the USB Type C interface is more versatile and has a wider range of use, and the type of interface of the charging connector 71 will not be specifically limited herein.

In an embodiment of the present disclosure, as shown in FIG. 2, the submersible thruster 100 further includes a driving component 90, the driving component 90 is arranged on an other side of the housing 10 and is connected to an other end of the fixing component 30, the housing 10, the charging component 70, and the driving component 90 are enclosed to form the containment cavity 101 therebetween, and the driving component 90 is electrically connected to the battery member 50.

In an embodiment, the driving component 90 is electrically connected to the battery member 50, thereby enabling the battery member 50 to provide electrical energy to the driving component 90, which in turn enables the driving component 90 to drive the propellers of the submersible thruster 100 to operate and propel the submersible thruster 100 forward.

In an embodiment of the present disclosure, as shown in FIG. 2, the driving component 90 includes a driving member 91 and a driving circuit board 93, the driving member 91 is connected to the other end of the fixing component 30, the driving circuit board 93 is arranged on the fixing component 30, and the driving circuit board 93 is electrically connected to the battery member 50 and the driving member 91 respectively.

In an embodiment, the power source of the battery member 50 is a direct current power source, which needs to be transformed into three-phase power after modulation of the driving circuit board 93, so as to make the driving member 91 work, and the driving member 91 drives the propeller to generate thrust, so as to provide driving force for the thruster, and the structure of the driving member 91 and the driving circuit board 93 is simple, and the power source is transformed with good effect, and the driving effect is good.

In an embodiment of the present disclosure, as shown in FIG. 1, the housing 10 is provided with a connecting through hole 11 outside.

In an embodiment, the connecting through hole 11 is provided so that other external equipment can be fixedly connected to the submersible thruster 100 through the connecting through hole 11, the equipment may be a diver, the diver's arm is provided with a hooping device, and there is a connecting component that can be cooperatively connected to the connecting through hole 11, so that the submersible thruster 100 is fixedly connected to the diver's arm to provide the diver with a diving propulsion power; of course, the external equipment can also be a bracket for divers to hold, the bracket is provided with a connecting component that can matched and connected with the connecting through hole 11, and the divers to dive through the hand-held bracket equipped with the submersible thruster 100; equipment can also be a small water surface underwater vehicles, such as small boat submarine, small boat submarine is equipped with connecting components that can matched and connected with the connecting through hole 11, and after being connected to the submersible thruster 100, the submersible thruster 100 can provide propulsion for the small boat submarine.

The structure of the connecting through hole 11 has a simple structure and good connection effect, which greatly reduces the production cost of the submersible thruster 100.

The above descriptions are only preferred embodiments of the present disclosure, and do not limit the patent scope of the present disclosure. Under the inventive concept of the present disclosure, equivalent structural transformations can be made using the contents of the description and drawings of the present disclosure, or direct/indirect application in other related technical fields is included in the scope of patent protection of the present disclosure.

What is claimed is:

1. A submersible thruster, comprising:
a housing, wherein a containment cavity is formed inside the housing;
a fixing component, wherein the fixing component is positioned in the containment cavity; and
a battery member, wherein the battery member is connected to the fixing component to form an integrated structure, and the fixing component is fixedly arranged in the containment cavity and connected to the housing to form an integrated structure.

2. The submersible thruster according to claim 1, wherein the fixing component comprises:
a fixing housing, wherein a fixing cavity is formed inside the fixing housing, and the battery member is fixedly and installed in the fixing cavity; and
a fixing rod, wherein an avoidance groove is formed on an outer side wall of the fixing housing, the fixing rod penetrates the fixing housing through the avoidance groove, and opposite ends of the fixing rod are connected to the housing respectively.

3. The submersible thruster according to claim 2, wherein the fixing component further comprises two fixing seats, the two fixing seats are arranged on opposite sides of the housing respectively, and the opposite ends of the fixing rod are connected to the two fixing seats respectively.

4. The submersible thruster according to claim 2, wherein the outer side wall of the fixing housing is provided with a pick-up port connected to the fixing cavity.

5. The submersible thruster according to claim 2, wherein a drive mounting position is arranged on the fixing housing.

6. The submersible thruster according to claim 1, wherein the submersible thruster further comprises a charging component;
the charging component is arranged on one side of the housing and is connected to one end of the fixing component, the housing and the charging component are enclosed to form the containment cavity therebetween, and the charging component is electrically connected to the battery member.

7. The submersible thruster according to claim 6, wherein the charging component comprises a charging connector and a power circuit board;
the power circuit board is connected to one end of the fixing component and electrically connected to the battery member, and the charging connector is electrically connected to the power circuit board and is partially exposed outside the housing.

8. The submersible thruster according to claim 6, further comprising a driving component;
wherein the driving component is arranged on an other side of the housing and is connected to an other end of the fixing component, the housing, the charging component, and the driving component are enclosed to form the containment cavity therebetween, and the driving component is electrically connected to the battery member.

9. The submersible thruster according to claim 8, wherein the driving component comprises a driving member and a driving circuit board;
the driving member is connected to the other end of the fixing component, the driving circuit board is arranged on the fixing component, and the driving circuit board is electrically connected to the battery member and the driving member respectively.

10. The submersible thruster according to claim 6, wherein the housing is provided with a connecting through hole outside.
